(19) United States
(12) Patent Application Publication
(10) Pub. No.: US 2026/0006587 A1
(43) Pub. Date: Jan. 1, 2026

(54) METHOD AND APPARATUS OF DYNAMIC ADAPTION OF SPATIAL ELEMENTS

(71) Applicant: LENOVO (BEIJING) LIMITED, Beijing (CN)

(72) Inventors: Hongmei LIU, Beijing (CN); Zhi YAN, Beijing (CN); Yuantao ZHANG, Beijing (CN); Yingying LI, Beijing (CN); Haiming WANG, Beijing (CN)

(21) Appl. No.: 18/881,568

(22) PCT Filed: Jul. 7, 2022
(86) PCT No.: PCT/CN2022/104340

§ 371 Date: Jan. 6, 2025

(51) Int. Cl. H04W 72/04; H04L 5/00

(52) U.S. Cl. CPC H04W 72/04; H04L 5/0048

(57) ABSTRACT

Embodiments of the present application are related to a method and apparatus of dynamic adaption of spatial elements. According an embodiment of the present application, an exemplary method includes: receive configuration information on at least one of: PDSCH with repetitions or PUSCH with repetitions; receive antenna port related information; and perform the at least one of PDSCH with repetitions or PUSCH with repetitions at least based on the antenna port related information in response to application of the antenna port related information.

### TECHNICAL FIELD

Embodiments of the present application generally relate to wireless communication technology, especially to a method and apparatus of dynamic adaption of spatial elements.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems. However, wireless communication system still needs to evolve to pursue better service quality, better service experience and lower cost.

For example, regarding spatial elements in the wireless communication system, they generally include antenna element(s), transmission (Tx) radio unit(s) (RU)(s) (with sub-array/full-connection), antenna panel(s), transmit receive point (TRxP)((s) (co-located or geographically separated from each other), and logical antenna port(s) (corresponding to specific signals and channels, also referred to as logic port(s) or antenna port(s)) etc. According to RAN1 #109e agreement, it is needed to further study techniques and enhancements for the adaptation of spatial elements, which includes but not limited to the following aspects:
impact to user equipment (UE) operations from dynamic adaptation of spatial elements, e.g. measurements, channel state information (CSI) feedback, power control, physical uplink shared channel (PUSCH)/physical downlink shared channel (PDSCH) repetition, sounding reference signal (SRS) transmission, transmission configuration indication (TCI) configuration, beam management, beam failure recovery, radio link monitoring, cell (re) selection, handover, initial access, etc.;
signaling methods, including reduced signaling, for enabling dynamic spatial element adaptation;
   for example, group-common layer 1 (L1) signaling, broadcast signaling, media access control (MAC) control element (CE), etc.
dynamic logical port adaptation and efficient port reconfigurations
   study details of signaling the port (e.g. non-zero-power (NZP) CSI-reference signal (RS) ports) (if required to be known by the UE)
   study dynamic adaptation (including activation/deactivation) of CSI measurement or report configuration for port adaptation.

### SUMMARY OF THE DISCLOSURE

An objective of the present application is at least to provide a technical solution of dynamic adaption of spatial elements, e.g., a technical solution of performing PDSCH with repetitions and/or PUSCH with repetitions in response to dynamic adjustment of spatial elements.

Some embodiments of the present application provide an exemplary remote apparatus, e.g., a UE, which includes a transceiver and a processor coupled to the transceiver. The processor is configured to: receive, via the transceiver, configuration information on at least one of: PDSCH with repetitions or PUSCH with repetitions; receive, via the transceiver, antenna port related information; and perform the at least one of PDSCH with repetitions or PUSCH with repetitions at least based on the antenna port related information in response to application of the antenna port related information.

Some other embodiments of the present application provide an exemplary method, e.g., a method performed by a UE, which includes: receive configuration information on at least one of: PDSCH with repetitions or PUSCH with repetitions; receive antenna port related information; and perform the at least one of PDSCH with repetitions or PUSCH with repetitions at least based on the antenna port related information in response to application of the antenna port related information.

In some embodiments of the present application, performing the at least one of PDSCH with repetitions or PUSCH with repetitions at least based on the antenna port related information includes: discarding remaining repetitions of the at least one of PDSCH with repetitions or PUSCH with repetitions in the case that the remaining repetitions are after the application of the antenna port related information.

In some embodiments of the present application, performing the at least one of PDSCH with repetitions or PUSCH with repetitions at least based on the antenna port related information includes: perform the at least one of PDSCH with repetitions or PUSCH with repetitions with at least one antenna port subset in response to the application of the antenna port related information, wherein, each of the at least one antenna port subset is a different subset of an antenna port set associated with the at least one of PDSCH with repetitions or PUSCH with repetitions before the application of the antenna port related information and is different from the antenna port set.

According to some embodiments of the present application, the at least one antenna port subset is configured, or is determined based on the antenna port set and the antenna port related information. The at least one antenna port subset is determined further based on codeword to layer mapping in some embodiments of the present application.

According to some embodiments of the present application, different antenna port subsets are mapped with different time instances of the at least one of PDSCH with repetitions or PUSCH with repetitions. Exemplary mapping between antenna port subsets and time instances is sequential or cyclic.

According to some embodiments of the present application, at least one of demodulation reference signal (DMRS) resource element (RE) location, a DMRS port index, a phase tracking reference signal (PTRS) port index, PTRS RE location or an associated DMRS port for a PTRS port for each time instance is determined based on a corresponding one of the at least antenna port subset, and the corresponding one is an antenna port subset for each time instance or is determined as an antenna port subset associated with a first time instance after the application of the antenna port related information. For example, the PTRS RE location is determined based on modulation and coding scheme associated with the corresponding one of the at least antenna port subset.

According to some embodiments of the present application, a time instance number of the at least one of PDSCH with repetitions or PUSCH with repetitions at least based on the antenna port related information is identical to that determined based on the configuration information, and a repetition number of the at least one of PDSCH with repetitions or PUSCH with repetitions associated with each antenna port subset is reduced compared with that determined based on the configuration information.

According to some embodiments of the present application, a repetition number of the at least one of PDSCH with repetitions or PUSCH with repetitions associated with each antenna port subset is identical to that determined based on the configuration information, and a time instance number of the at least one of PDSCH with repetitions or PUSCH with repetitions at least based on the antenna port related information is larger than or equal to that determined based on the configuration information.

According to some embodiments of the present application, in the case that different repetitions of the at least one of PDSCH with repetitions or PUSCH with repetitions at different time instances are associated with different transmission configuration indication (TCI) states, the antenna port related information is applied to one of the TCI states or to all the TCI states. For example, in the case that the antenna port related information is applied to all the TCI states, mapping the TCI states and the at least one antenna port subset to time instances for the at least one of PDSCH with repetitions or PUSCH with repetitions is performed by: antenna port subsets firstly and TCI states secondly; or TCI states firstly and antenna port subsets secondly. In another example, in the case that the antenna port related information is applied to one TCI state, time instances for other TCI state of the TCI states are impacted by the application of the antenna port related information to the one TCI states.

According to some embodiments of the present application, in the case that different repetitions of the at least one of PDSCH with repetitions or PUSCH with repetitions for different frequency domain resource sets are associated with different TCI states, the antenna port related information is applied to one of the TCI states or all the TCI states. In an example, at least one of a PTRS port index or an associated DMRS port for a PTRS port for each frequency domain resource set is determined based on an antenna port subset associated with a corresponding frequency domain resource set.

According to some embodiments of the present application, in the case that there are two TCI states and two DMRS code division multiplexing (CDM) groups, different repetitions of the at least one of PDSCH with repetitions or PUSCH with repetitions are associated with different TCI states and different DMRS CDM groups, and a PDSCH repetition or PUSCH repetition in a time instance associated with a TCI state is dropped in response to associated DMRS ports within a DMRS CDM group being dropped in response to the application of the antenna port related information.

According to some embodiments of the present application, in the case of mapping the at least one antenna port subset to time instances, a time instance number is determined based on a joint channel estimation window size. A starting time domain position of the joint channel estimation windows for different antenna port subsets is different.

According to some embodiments of the present application, at least one of a PTRS port index or an associated DMRS port for a PTRS port for each time instance is determined based on a SRS resource index associated with a corresponding one of the at least one antenna port subset.

According to some embodiments of the present application, codeword to layer mapping for an antenna port within an antenna port subset and a same antenna port within the antenna port set is same or different.

In some embodiments of the present application, the antenna port related information is separate or jointly for downlink and uplink.

In some embodiments of the present application, application time of the antenna port related information is configured or is determined based on a time instance when all configured PDSCH with repetitions or PUSCH with repetitions performed before receiving the antenna port related information is finished.

Some yet other embodiments of the present application provide an exemplary radio access network (RAN) node, e.g., a gNB, which includes a transceiver and a processor coupled to the transceiver. The processor is configured to: transmit, via the transceiver, configuration information on at least one of: PDSCH with repetitions or PUSCH with repetitions; transmit, via the transceiver, antenna port related information; and perform the at least one of PDSCH with repetitions or PUSCH with repetitions at least based on the antenna port related information in response to application of the antenna port related information.

Given the above, embodiments of the present application provide a technical solution of dynamic adaption of spatial elements, e.g., dynamic adaption of PUSCH with repetitions and/or PDSCH with repetitions in response to antenna port number adjustment, and thus will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary procedure of a method of dynamic adaption of spatial elements according to some embodiments of the present application.

FIG. 3 is a schematic diagram illustrating a SPS PDSCH of dynamic adaption of spatial elements according to some embodiments of the present application.

FIG. 4 is a schematic diagram illustrating a PDSCH with TDMSchemeA of dynamic adaption of spatial elements according to some embodiments of the present application.

FIG. 5a is a schematic diagram illustrating a PDSCH with FDMSchemeA of dynamic adaption of spatial elements according to some embodiments of the present application.

FIG. 5b is a schematic diagram illustrating a PDSCH with FDMSchemeB of dynamic adaption of spatial elements according to some embodiments of the present application.

FIG. 6 is a schematic diagram illustrating non-SFN PDSCH repetitions of dynamic adaption of spatial elements according to some embodiments of the present application.

FIG. 7 illustrates a block diagram of an exemplary apparatus of dynamic adaption of spatial elements according to some embodiments of the present application.

FIG. 8 illustrates a block diagram of an exemplary apparatus of dynamic adaption of spatial elements according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

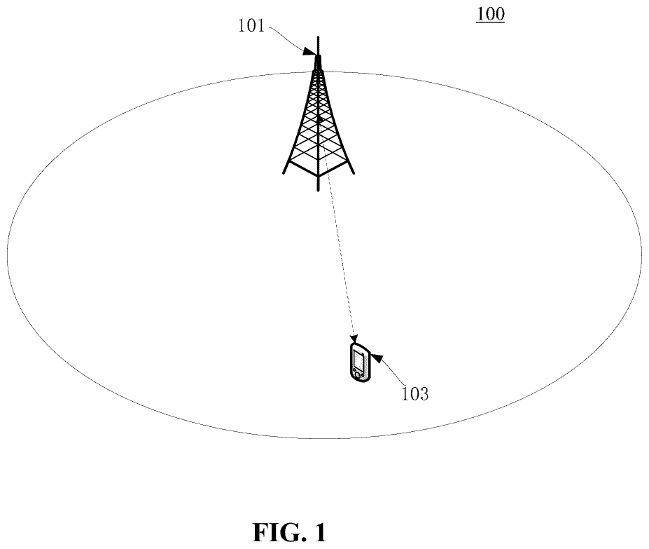

FIG. 1 illustrates a schematic diagram of an exemplary wireless communication system 100 according to some embodiments of the present application.

As shown in FIG. 1, the wireless communication system 100 includes a UE 103 and a BS 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one transmit-receive point (TRP) (or panel), i.e., in a single-TRP scenario or more TRPs (or panels), i.e., a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to RAN1 #109e agreement, there will be techniques and enhancements for adaptation of number of spatial elements of the gNB, and there will be impact to UE operations including PUSCH/PDSCH repetitions from dynamic adaptation of spatial elements. For example, the number of antenna ports at a gNB may be adjusted for network energy saving, while the application of the adjusted antenna port number may be during the operation of PDSCH/PUSCH repetitions, wherein at least one repetition of the PDSCH/PUSCH repetitions has not been completely performed yet. Thus, how to handle such PDSCH/PUSCH repetitions should be considered and solved.

At least considering the above study item, embodiments of the present application propose a technical solution of dynamic adaption of spatial elements, e.g., a method and apparatus of dynamic adaption of spatial elements, which mainly focuses on impact to PUSCH/PDSCH repetitions caused by antenna port number adjustment.

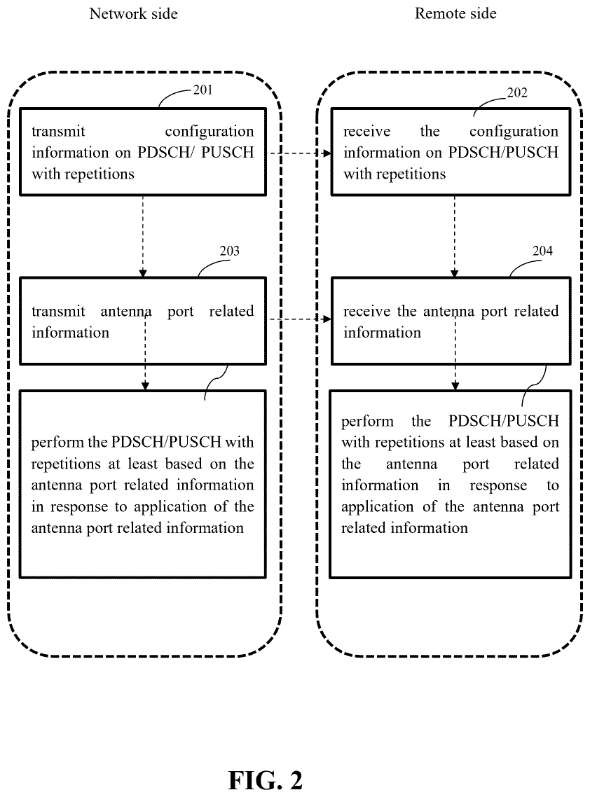

FIG. 2 is a flow chart illustrating an exemplary procedure of a method of dynamic adaption of spatial elements according to some embodiments of the present application. Although the method is illustrated in a system level between a RAN node, e.g., a gNB and a remote apparatus, e.g., a UE, persons skilled in the art should understand that the method implemented in the RAN node and the remote apparatus can be separately implemented and/or incorporated by other apparatus with the like functions.

Referring to FIG. 2, the RAN node, e.g., a gNB may semi-statically or dynamically configure (including: schedule or activate etc. in some scenarios) at least one of PDSCH or PUSCH for a UE. In some scenarios, the at least one of PDSCH or PUSCH may be at least one of PDSCH with repetitions or PUSCH with repetitions (hereafter, PDSCH with repetitions and/or PUSCH with repetitions, or PDSCH/PUSCH with repetitions) to enhance coverage or to improve reliability etc. Taking PDSCH with repetitions (or PDSCH repetitions) as an example, it is semi-statically or dynamically scheduled, wherein semi-static scheduling PDSCH is also referred to as semi-persistent scheduling (SPS) PDSCH. Exemplary PDSCH repetition scheme can be SFNSchemeA (quasi co-location (QCL) among two TRPs), SFNSchemeB (QCL among two TRPs except Doppler shift and Doppler spread), TDMSchemeA, FDMSchemeA (single PDSCH occasion), or FDMSchemeB (two PDSCH occasions).

Configuration information of PDSCH with repetitions and/or PUSCH with repetitions may also include other information.

For example, configuration information of PDSCH repetitions also includes PDSCH DMRS configuration. The DMRS port indexes may range from 0 to 11. According to legacy technology, for single-user (SU) multiple-input multiple-output (MIMO), a UE can be configured with up to 8 antenna ports; and for multiple-users (MU) MIMO, all UEs can be configured with up to 12 antenna ports. The number of DMRS CDM groups without data can be used to determine whether there is another UE sharing the same time and/or frequency resource(s) with different spatial domain resource(s).

Configuration information of PDSCH repetitions also includes PDSCH PTRS configuration. When there are two codewords, a PTRS port is associated with the lowest indexed DMRS port of the codewords with a larger modulation coding scheme (MCS) index. When there is one codeword, the PTRS port is associated with the lowest indexed DMRS port of the codeword. When the UE is not configured with a single frequency network (SFN) scheme, and is configured with two TCI states and DMRS ports in two DMRS CDM groups, there will be two PTRS ports, and each PTRS port for each DMRS CDM group and each TCI state. When the UE is configured with FDMSchemeA or FDMSchemeB, and there are two TCI states and DMRS ports in one DMRS CDM group, there will be one PTRS port, and the RE mapping is associated with the allocated physical resource blocks (PRB) s associated with each TCI state.

Similarly, configuration information of PUSCH repetitions also includes PUSCH DMRS configuration. For SU MIMO, at most 4 layers and/or DMRS ports can be configured for a single UE. For MU MIMO, at most 12 layers and/or DMRS ports can be configured for multiple UEs.

Regarding PUSCH PTRS configuration, for codebook based PUSCH, a UE can report the capability of full coherent, partial coherent or non-coherent. The network side can indicate to the UE the coherent type by transmitted precoding matrix indicator (TPMI). There will be different number of PTRS ports corresponding to different coherent capabilities. For non-codebook based PUSCH, a sounding reference signal (SRS) resource is configured to be associated with a PTRS port, multiple SRS resources will be indicated by a SRS resource indicator (SRI) for the non-codebook based PUSCH. The number of PTRS ports is determined by the SRI. In the case that all SRS resources indicated by the SRI are associated with a same PTRS port, then the number of PTRS ports is 1; otherwise, the number of PTRS ports is larger than 1. Association between DMRS and PTRS can be further determined by signaling in downlink control information (DCI).

In addition, a window may be configured from the network side to the UE side to perform a PUSCH joint channel estimation.

In step 201, the RAN node will transmit configuration information on the PDSCH with repetitions and/or PUSCH with repetitions to the UE, e.g., by DCI, MAC CE and/or radio resource control (RRC) signaling etc. Accordingly, the UE will receive the configuration information on the PDSCH with repetitions and/or PUSCH with repetitions in step 202. Based on the received configuration information on the PDSCH with repetitions and/or PUSCH with repetitions, the UE will perform the PDSCH with repetitions and/or PUSCH with repetitions in the corresponding time and/or frequency resources, e.g., receiving the PDSCH with repetitions in the case of PDSCH with repetitions being configured and transmitting the PUSCH with repetitions in the case of PUSCH with repetitions being configured.

The RAN node may dynamically adjust the spatial elements, e.g., adjusting the number of antenna ports in some scenarios. In step 203, the RAN node will transmit antenna port related information to the UE to indicate the adjustment, which may explicitly indicate the adjusted antenna port number or implicitly the adjusted antenna port number, e.g., by indicating a row index of a table for CSI-RS locations within a slot etc. The antenna port related information can be configured per cell or per TRP, and can be separate or jointly configured for downlink, e.g., PDSCH and uplink, e.g., PUSCH. Accordingly, the UE will receive the antenna port related information in step 204.

Exemplary signaling of transmitting (or indicating) the antenna port related information may be DCI, MAC CE or their combination. The type of DCI is various, e.g., group common DCI or aperiodic DCI etc. In some scenarios, there may be more than one signaling respectively indicating the antenna port related information to the UE for different time instances (or time domain resources). Accordingly, if there is more than one signaling indicating the antenna port related information at the same time, the latest signaling will be applied according to some embodiments of the present application. However, in some other embodiments of the present application, group common DCI may always have the highest priority regardless of whether it is the latest signaling; and in the case that there is more than one group common DCI at the same time, the latest group common DCI will be applied. In addition, although the wording “adjustment” or “updated” or the like is used, it does not mean the adjusted spatial elements must be different from the previous one(s). The adjusted spatial elements may be the same as or different from those before the adjustment.

Application time of the antenna port related information can be configured by the network side, e.g., by a gNB or can be determined in the UE side based on a predefined rule(s), e.g., based on a time instance when all configured PDSCH repetitions and/or PUSCH repetitions before reception of the antenna port related information are finished.

In response to the spatial elements being adjusted, the RAN node and the UE will perform corresponding operations to adapt the adjusted spatial elements, which are various according to some embodiments of the present application. For example, in step 205, the RAN node will perform the PDSCH with repetitions and/or PUSCH with repetitions at least based on the antenna port related information in response to the application of the antenna port related information. Similarly, in step 206, the UE will also perform the PDSCH with repetitions and/or PUSCH with repetitions at least based on the antenna port related information in response to the application of the antenna port related information. For example, regarding PDSCH, the RAN node will transmit the PDSCH with repetitions to the UE at least based on the antenna port related information, and the UE will receive the PDSCH with repetitions at least based on the antenna port related information. Regarding PUSCH, the UE will transmit the PUSCH scheduled by the RAN node at least based on the antenna port related information, and the RAN node will receive the PUSCH with repetitions from the UE at least based on the antenna port related information.

Regarding how to perform the PDSCH with repetitions and/or PUSCH with repetitions in response to the application of the antenna port related information, there are various embodiments according to the present application. For example, in some embodiments of the present application, for the PDSCH with repetitions and/or PUSCH with repetitions, in the case that there are remaining repetition(s) has not be completed when the antenna port related information is applied, the remaining repetition(s) will be discarded or dropped. That is, remaining repetitions of the PDSCH with repetitions and/or PUSCH with repetitions will be discarded or dropped in the case that the remaining repetitions are after the application of the antenna port related information. In some scenarios, for the PDSCH with repetitions and/or PUSCH with repetitions configured according to the adjusted antenna port number, although the PDSCH with repetitions and/or PUSCH with repetitions starts after the application of the antenna port related information, the whole PDSCH with repetitions and/or PUSCH with repetitions will be discarded or dropped. That is, the remaining repetition(s) repetition(s) may be the whole repetitions of the PDSCH with repetitions and/or PUSCH with repetitions in some scenarios.

According to some other embodiments of the present application, the remaining repetitions after the application of the antenna port related information will not be directly discarded or dropped, and will be performed according to the antenna port related information. According to some yet other embodiments of the present application, in the case that there is remaining repetition(s) after the application of the antenna port related information, the whole PDSCH with repetitions and/or PUSCH with repetitions will be performed according to the adjusted antenna port number. Persons skilled in the art should well know that performing the remaining repetitions according to the antenna port related information does not mean the remaining repetitions will be performed in the same manner. In some scenarios, e.g., a reduced antenna port number being indicated in the antenna port related information, one or more repetitions may also be dropped when performing the remaining repetition(s) after the application of the antenna port related information. The number of time instances and/or the number of repetitions performed in response to the antenna port related information may change compared with that originally provided in the configuration information.

According to some embodiments of the present application, in response to the application of the antenna port related information, the PDSCH with repetitions and/or PUSCH with repetitions is performed with at least one antenna port subset, wherein, each antenna port subset is a different subset of an antenna port set associated with the PDSCH with repetitions and/or PUSCH with repetitions before the application of the antenna port related information (e.g., the originally configured antenna ports in step 201) and is different from the antenna port set. In the case that the spatial element number, e.g., the antenna port number is reduced, the antenna port number in each antenna port subset is not larger than the reduced antenna port number.

The division manner of the at least one antenna port subset is various. In some scenarios, the at least one antenna port subset can be configured by the network side, e.g., by the gNB, or can be determined based on the antenna port set and the antenna port related information. In some other scenarios, the at least one antenna port subset can be further determined based on codeword to layer mapping, that is, the at least one antenna port subset can be determined based on the antenna port set, the antenna port related information and codeword to layer mapping. The codeword to layer mapping for an antenna port within an antenna port subset and the same antenna port within the antenna port set is the same or different.

Different antenna port subsets can be mapped with different time instances of the PDSCH with repetitions and/or PUSCH with repetitions in various manners. For example, different antenna port subsets can be sequentially or cyclically mapped with different time instances of the PDSCH with repetitions and/or PUSCH with repetitions. Considering joint channel estimation, in the case of mapping the at least one antenna port subset to time instances, a number of time instances for an antenna port subset is determined based on a joint channel estimation window size. The starting time domain position of the joint channel estimation windows for different antenna port subset is different. The starting time domain position may be based on the first time instance for the antenna port subset. For example, antenna port subset #0 occupies time instances #1, #2, #3, #4 with 4 repetitions, and antenna port subset #1 occupies time instances #5, #6, #7, #8 with 4 repetitions. Then the starting position for antenna port subset #0 is time instance #1, and the starting position for antenna port subset #1 is time instance #5.

When the number of PDSCH repetitions and/or PUSCH repetitions is configured instead of being determined by activation and deactivation, the number of time instances for the antenna port subset can be the same or different from that originally configured. For example, in some embodiments of the present application, a time instance number of the PDSCH with repetitions and/or PUSCH with repetitions at least based on the antenna port related information is identical to that determined based on the configuration information, but a repetition number of the PDSCH with repetitions and/or PUSCH with repetitions associated with each antenna port subset is changed compared with that determined based on the configuration information, e.g., being reduced when the antenna port is reduced. In some other embodiments of the present application, a repetition number of the PDSCH with repetitions and/or PUSCH with repetitions associated with each antenna port subset is identical to that determined based on the configuration information, but a time instance number of the PDSCH with repetitions and/or PUSCH with repetitions at least based on the antenna port related information is changed, e.g., larger than or equal to that determined based on the configuration information.

In the case that different repetitions of the PDSCH with repetitions and/or PUSCH with repetitions at different time instances are associated with different TCI states, the antenna port related information is applied to one of the TCI states or to all the TCI states. Each TCI state can be associated with a TRP. For example, in the case that the antenna port related information is applied to all the TCI states, mapping the TCI states and the at least one antenna port subset to time instances for the PDSCH with repetitions and/or PUSCH with repetitions is performed by: antenna port subsets firstly and TCI states secondly; or TCI states firstly and antenna port subsets secondly. In another example, in the case that the antenna port related information is applied to one TCI state, time instances for another TCI state of the TCI states are impacted by the application of the antenna port related information to the one TCI states. Similarly, in the case that different repetitions of the PDSCH with repetitions and/or PUSCH with repetitions for different frequency domain resource sets are associated with different TCI states, the antenna port related information is applied to one of the TCI states or all the TCI states.

Impact to PDSCH with repetitions and/or PUSCH with repetitions also includes other configurations, e.g., PDSCH DMRS configuration, PDSCH PTRS configuration, PUSCH DMRS configuration, PUSCH PTRS configuration, and joint channel estimation etc.

For example, according to some embodiments of the present application, at least one of DMRS RE location, a DMRS port index, a PTRS port index, PTRS RE location or an associated DMRS port for a PTRS port for each time instance is determined based on a corresponding antenna port subset. The corresponding antenna port subset is an antenna port subset for each time instance or is determined as an antenna port subset associated with the first time instance after the application of the antenna port related information. The PTRS RE location, time domain density or frequency domain density can be further determined based on a MCS index, e.g., a larger one associated with the corresponding antenna port subset in the case that there are two MCS values for two codewords.

According to some embodiments of the present application, in the case that different repetitions of PDSCH with repetitions and/or PUSCH with repetitions are for different frequency domain resource sets, e.g., different repetitions of PDSCH with FDMSchemeA or FDMSchemeB, at least one of a PTRS port index or an associated DMRS port for a PTRS port for each frequency domain resource set is determined based on an antenna port subset associated with a corresponding frequency domain resource set.

In the case that there are two TCI states and two DMRS CDM groups, different repetitions of the PDSCH with repetitions and/or PUSCH with repetitions are associated with different TCI states and different DMRS CDM groups, and a PDSCH repetition or PUSCH repetition in a time instance associated with a TCI state is dropped in response to associated DMRS ports within a DMRS CDM group being dropped in response to the application of the antenna port related information.

In some embodiments of the present application, at least one of a PTRS port index or an associated DMRS port for a PTRS port for each time instance is determined based on a SRS resource index associated with a corresponding antenna port subset.

To help understand the technical solution of the present application, more detailed embodiments of the present application will be illustrated in view of current exemplary PDSCH schemes and PUSCH schemes in the following. Since the solution of directly discarding the remaining repetitions after the application of the antenna port related information is simple, it will not be repeated. In addition, persons skilled in the art should well know that due to the consistency between the network side and remote side, although some embodiments are illustrated only concerning on one side as an example, the corresponding operations in the other side should also be determined except for special operations.

First, some exemplary embodiments will be illustrated in view of SPS PDSCH. For an exemplary SPS PDSCH, different PDSCH occasions at different time instances are associated with the same DMRS port(s) and the same TCI state.

According to some embodiments of the present application, in response to the application of the antenna port related information, e.g., information indicating a number of antenna ports smaller than that originally configured for the PDSCH, the configuration information including antenna port(s) for the PDSCH will be adjusted.

Specifically, regarding the antenna ports originally configured for the PDSCH as an antenna port set, at least one antenna ports subset will be divided (or grouped or determined) from the antenna port set according a predefined rule or a signaling configured by the network side. Each antenna port subset is a different subset of the antenna port set and is different from the antenna port set. An exemplary predefined rule may define how the at least one subset is determined based on the antenna port set and the antenna port related information.

Each antenna port subset can be mapped to time instances of the PDSCH to be performed in response to the application of the antenna port related information in a sequential manner or a cyclic manner or other manners. The number of repetitions of each antenna port subset can be configured, or determined, e.g., by the number of remaining repetitions, e.g., N and the number of antenna port subsets, e.g., M. An exemplary determination manner is: floor(N/M) or ceil(N/M).

For example, there are two antenna port subsets, e.g., subset #1 and subset #2 in response to the application of antenna port related information and the repetition number for each antenna port subset is 2; and then, the sequential mapping between the two antenna port subsets and the corresponding time instances is subset #1, subset #1, subset #2 and subset #2, and the cyclic mapping between the two antenna port subsets and corresponding time instances is subset #1, subset #2, subset #1 and subset #2.

The number of PDSCH with repetitions can be determined by activation and deactivation, or is configured. When the PDSCH repetition number is configured, the number of time instances for the PDSCH after the application of the antenna related information will not change and still be the same as the originally configured while the repetition number for each antenna port will be adjusted, e.g., being reduced due to reduced antenna port number. In another example, when the PDSCH repetition number is configured, the number of time instances for the PDSCH after the application of the antenna related information will be different from the originally configured while the repetition number for each antenna port will not change and will be the same as the originally configured.

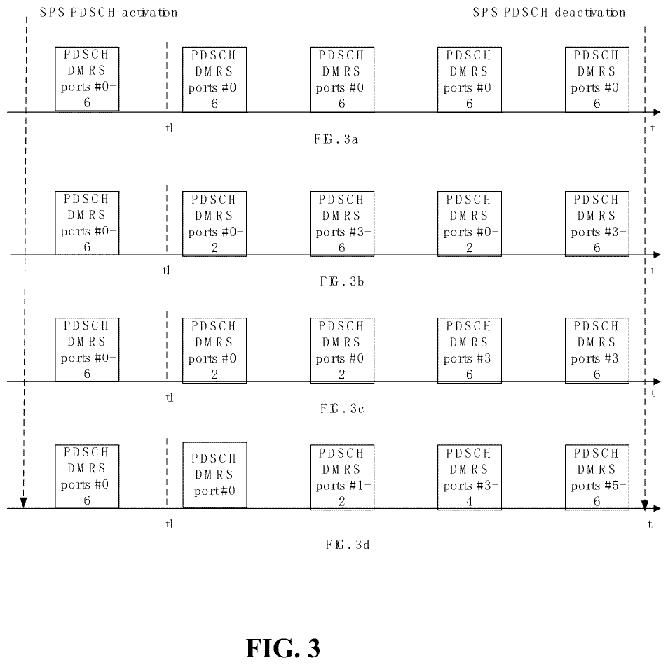

FIG. 3 is a schematic diagram illustrating a SPS PDSCH of dynamic adaption of spatial elements according to some embodiments of the present application, wherein FIG. 3a illustrates the originally configured SPS PDSCH according to some embodiments of the present application, FIG. 3b illustrates the adjusted SPS PDSCH after the adaption of spatial elements with two antenna port subsets in sequential mapping according to some embodiments of the present application, FIG. 3c illustrates the adjusted SPS PDSCH after the adaption of spatial elements with two antenna port subsets in cyclic mapping according to some embodiments of the present application, and FIG. 3d illustrates the adjusted SPS PDSCH after the adaption of spatial elements with four antenna port subsets in sequential mapping according to some embodiments of the present application.

Referring to FIG. 3, in all scenarios shown in FIGS. 3a to 3d, the number of PDSCH repetitions is not explicitly configured while is determined by activation and deactivation, and there are 5 time instances and 5 repetitions.

As shown in FIG. 3a, antenna ports #0 to #6 (corresponding to DMRS ports #0 to 6) are configured for a SPS PDSCH. Different PDSCH occasions at different time instances are associated with the same DMRS port(s) (e.g., DMRS ports #0 to #6) and TCI state (not shown).

Referring to FIGS. 3b to FIG. 3d, antenna port related information is applied in time t1, which is after the first repetition and before the second repetition. That is, there are 4 remaining repetitions corresponding to 4 time instances after the application of the antenna port related information. FIGS. 3b to 3d respectively illustrate different division manners and mapping manners.

In FIG. 3b, the antenna port related information indicates that the antenna port is reduced to 4. An exemplary division manner is: dividing the original 7 antenna ports, e.g., antenna ports #0 to #6 into two subsets, e.g., the first subset including 3 antenna ports, e.g., antenna ports #0 to #2 (corresponding to DMRS ports #0 to #2) and the second subset including 4 antenna ports, e.g., antenna ports #3 to #6 (corresponding to DMRS ports #3 to #6). The two antenna port subsets are cyclically mapped to the 4 time instances. The antenna port subset associated with time instances #2, #3, #4, #5 are antenna subsets #1, #2, #1, #2.

In FIG. 3c, the antenna port related information also indicates that the antenna port is reduced to 4. Similar to FIG. 3b, an exemplary division manner is: dividing the original 7 antenna ports, e.g., antenna ports #0 to #6 into two subsets, e.g., the first subset including 3 antenna ports, e.g., antenna ports #0 to #2 and the second subset including 4 antenna ports, e.g., antenna ports #3 to #6. However, different from FIG. 3b, the two antenna port subsets are sequentially mapped to the 4 time instances. The antenna port subsets associated with time instances #2, #3, #4, #5 are antenna subsets #1, #1, #2, #2.

In FIG. 3d, the antenna port related information indicates that the antenna port is reduced to 2. An exemplary division manner is: dividing the original 7 antenna ports into four subsets, e.g., the first subset including 1 antenna port, e.g., antenna port #0, the second subset including 2 antenna ports, e.g., antenna ports #1 to #2, the third subset including 2 antenna ports, e.g., antenna ports #3 to #4, and the fourth subset including 2 antenna ports, e.g., antenna ports #5 to #6. The four antenna port subsets are mapped to the 4 time instances.

Another exemplary predefined rule may define how the at least one antenna port subset is determined further based on codeword to layer mapping. For each time instance, the layer mapping in response to the application of antenna port related information can be based on the originally configured number of antenna ports (based on the antenna port set) or the adjusted number of antenna ports (based on the at least one antenna port subset). Codeword to layer mapping in response to the application of antenna port related information based on the originally configured number of antenna ports and that based on the adjusted number of antenna ports can be the same or different.

For example, the original antenna port number for PDSCH is 7, while the antenna port related information, e.g., indicated by an antenna port adjustment signaling indicates that the antenna port is reduced to 5. An exemplary division manner is: dividing the 7 antenna ports, e.g., antenna ports #0 to #6 into two subsets, e.g., the first subset including 3 antenna ports, e.g., antenna ports #0 to #2 and the second subset including 4 antenna ports, e.g., antenna ports #3 to #6. In such a division manner, codeword to layer mapping is the same regardless of whether the antenna port set is divided into at least one antenna port subset or not. The reason is that when there are 7 antenna ports (#0 to #6), there will be two codewords. The first codeword is associated with antenna ports #0 to #2, and the second codeword is associated with antenna ports #3 to #6. After antenna port adjustment, antenna ports #0 to #2 will construct the first antenna port subset, and antenna ports #3 to #6 will construct the second antenna port subset. So the antenna port grouping are the same before and after the application of antenna port related information. Another exemplary division manner is dividing the 7 antenna ports, e.g., antenna ports #0 to #6 into three subsets. The first subset includes 2 antenna ports, e.g., antenna ports #0 to #1, the second subset including 3 antenna ports, e.g., antenna ports #2 to #4, and the third subset including 2 antenna ports, e.g., antenna ports #5 to #6. In such a division manner, codeword to layer mapping before the application of the antenna port related information and that after the application of the antenna port related information is different. The reason is that before the application of the antenna port adjustment signaling, there will be two codewords, corresponding to antenna ports #0 to #2 and antenna ports #3 to #6. And after the application of the antenna port adjustment signaling, there will be three antenna port subsets, #0 to #1, #2 to #4, and #5 to #5. After the application of the port adjustment signaling, each antenna port subset will be associated with a single codeword. So it can be concluded that the codeword to layer mapping is changed compared to that before the application of the antenna port adjustment signaling.

Regarding PTRS related aspect determination, e.g., PTRS port index, PTRS RE location and associated DMRS port for a PTRS port etc., there are also various manners. For example, for each time instance, PTRS and DMRS association (e.g., PTRS port with DMRS port association) will be determined within each antenna port subset (an antenna port subset corresponding to each time instance). Since the DMRS port for different time instances are different, the associated DMRS port for a PTRS port will be also different. PTRS time and/or frequency domain density can be determined based on the corresponding antenna port subset for each time instance, e.g., MCS index of the corresponding antenna port subset for each time instance, or based on the first antenna port subset. Based on the determined PTRS time and/or frequency domain density, the PTRS RE location can also be determined. In the case that there are two codewords for the corresponding antenna port subset for each time instance, the PTRS related aspect determination will be associated with the lowest DMRS port index of the codeword with a higher MCS index. In the case that there is one codeword for the corresponding antenna port subset for each time instance, the PTRS related aspect determination will be associated with the lowest DMRS port index.

For PDSCH with SFNSChemeA and SFNSchemeB, when the antenna port related information is applied, similar solutions to PDSCH with SPS PDSCH will be performed, and thus no specific embodiments will be further illustrated.

Second, some exemplary embodiments will be illustrated in view of PDSCH with TDMSchemeA.

For a PDSCH with TDMSchemeA, different time instances (time resources) may be associated with different TCI states. For example, there are two TCI states and one DMRS CDM group in a PDSCH with TDMSchemeA. Different TCI states may correspond to different TRPs at the network side. For example, in the case that there are two TRPs and two TCI states, the first TCI state is associated with the first TRP and the second TCI state is associated with the second TRP. The spatial element adjustment, e.g., antenna port adjustment can be applied to a single TRP (or a TCI state) or for both the TRPs (or both the two TCI states). Whether the antenna port related information is applied to the first TRP associated with the first TCI state, the second TRP associated with the second TCI state, or both the TRPs associated with the two TCI states can be configured by the network side or predefined.

For example, in the case that the antenna port related information is applied to both the two TCI states, the TCI states and the at least one antenna port subset can be mapped to time instances for the PDSCH with repetitions by: antenna port subsets firstly and TCI states secondly, or TCI states firstly and antenna port subsets secondly. In the case that the antenna port related information is applied to one TCI state, time instances for the other TCI state will be impacted by the application of the antenna port related information to the one TCI states.

In addition, if the antenna port related information is applied to a single TCI state only, the application of the antenna port related information to the single TCI state will start from the first time instance associated with the corresponding TCI state after the antenna port related information is applicable in the UE side, which may be different from the application time of the antenna port related information applicable in the UE side. The mapping between antenna port subsets and time instance can be the same as that illustrated to SPS PDSCH, and will not be repeated.

Regarding PTRS related aspect determination for PDSCH with TDMSchemeA, there will be one PTRS port for each time instance, and the associated DMRS port for the PTRS port will be determined by the antenna port subset for each time instance. Details are similar to that of SPS PDSCH, and thus will not be repeated herein.

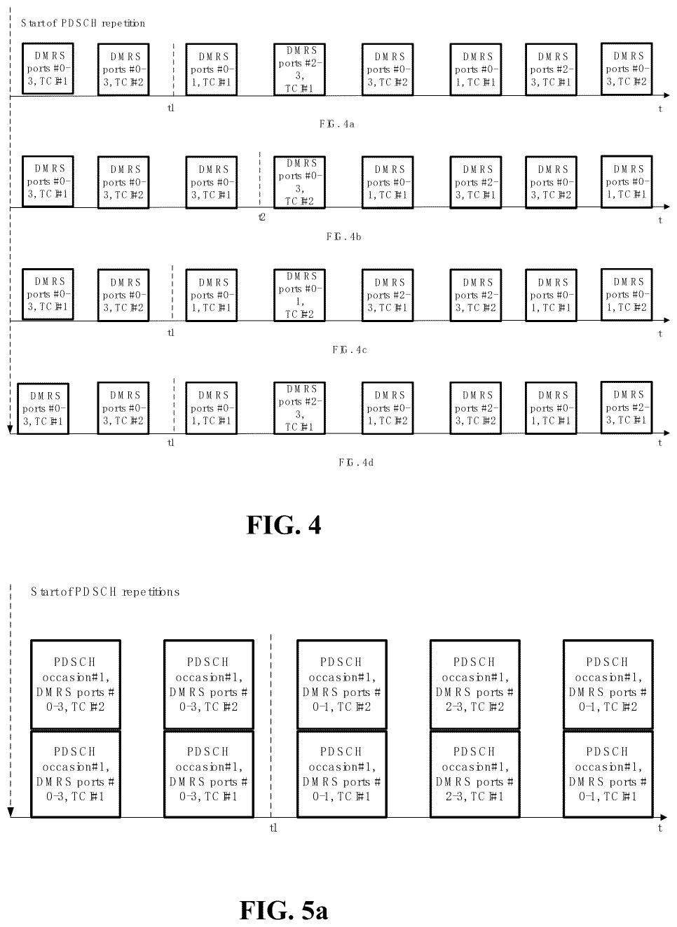

FIG. 4 is a schematic diagram illustrating a PDSCH with TDMSchemeA of dynamic adaption of spatial elements according to some embodiments of the present application, wherein FIGS. 4a and 4b illustrate the scenarios that the antenna port related information is only applied to a single TCI state according to some embodiments of the present application, and FIGS. 4c and 4d illustrates the scenarios that the antenna port related information is applied to two TCI states according to some embodiments of the present application.

Referring to FIG. 4, in all scenarios shown in FIGS. 4a to 4d, for the PDSCH with TDMSchemeA, 8 time instances and 8 repetitions are shown as an example. There are two TCI states, e.g., TCI #1 and TCI #2 and one DMRS CDM group, e.g., a DMRS CDM group including four DMRS ports, e.g., DMRS ports #0 to #3 (corresponding to 4 antenna ports) in the PDSCH with TDMSchemeA.

Referring to FIG. 4a, antenna port related information is applicable in the UE side in time t1, which is after the first repetition associated with TCI #2 and before the second repetition associated with TCI #1. In addition, the antenna port related information is only applied to the first TCI state, e.g., TCI #1, which will start from the first time instance associated with TCI #1 after the antenna port related information is applicable in the UE side, i.e., the second repetition associated with TCI #1 as originally configured. Thus, the application of the antenna port related information in the UE side is consistent to that applied to the single TCI state. In response to the application of the antenna port related information to the first TCI state, an exemplary division manner of antenna port subsets associated with the first TCI state is: dividing the four antenna ports into 2 subsets associated with the first TCI state, e.g., the first subset including antenna ports #0 to #1 (DMRS ports #0 to #1) and the second subset including antenna ports #2 to #3 (DMRS ports #2 to #3). The two subsets associated with the first TCI state are mapped to the corresponding time instances.

Similar to FIG. 4a, the antenna port related information is also only applied to the first TCI state. The difference between FIG. 4a and FIG. 4b is the application time of the antenna port related information to the first TCI state. Since the antenna port related information is applicable in the UE side in time t2, which is after the second repetition associated with the first TCI state and before the second repetition associated with the second TCI state, the first time instance associated with the first TCI state after the antenna port related information is applicable in the UE side is the third repetition associated with the first TCI state as originally configured. That is, the application of the antenna port related information to the first TCI state will start from the third repetition associated with the first TCI state as originally configured.

Referring to FIGS. 4c and 4d, antenna port related information is applicable in the UE side in time t1, which is after the first repetition associated with the second TCI state and before the second repetition associated with the first TCI state. In addition, the antenna port related information is applied to both the two TCI states. Thus, for each TCI state, the application of the antenna port related information will start from the corresponding first time instance after the antenna port related information is applicable in the UE side, i.e., the second repetition associated with each TCI state as originally configured. In response to the application of the antenna port related information to each TCI state, an exemplary division manner of antenna port subsets is dividing the four antenna ports into 2 subsets, e.g., the first subset including antenna ports #0 to #1 (DMRS ports #0 to #1) and the second subset including antenna ports #2 to #3 (DMRS ports #2 to #3).

The difference between FIG. 4c and FIG. 4d lies in the manner that the two TCI states and the two antenna port subsets mapped to time instances. In FIG. 4c, the two TCI states and the two antenna port subsets are mapped to the time instances for PDSCH by TCI states firstly and antenna port subsets secondly; while in FIG. 4c, the two TCI states and the two antenna port subsets are mapped to the time instances for PDSCH by antenna port subsets firstly and TCI states secondly.

Third, some exemplary embodiments will be illustrated in view of PDSCH with FDMSchemeA and FDMSchemeB.

For PDSCH with FDMSchemeA, there is a single PDSCH occasion. So, in the case of two TCI states, no matter the antenna port related information is indicated to which TCI state, it will be applied to both the two TCI states. The mapping between antenna port subsets and time instance for each TCI state can be the same as that illustrated to SPS PDSCH, and thus will not be repeated.

Regarding PTRS related aspect determination for PDSCH with FDMSchemeA, for each frequency domain resource, the associated DMRS port is determined based on the antenna port subset after the application of the antenna related information. The PTRS time and/or frequency density can be kept as the same as the originally configured, e.g., that in legacy technology, and accordingly the PTRS RE location can also be the same as that in legacy technology. The PTRS time and/or frequency density, and correspondingly PTRS RE location can also be updated based on the updated antenna port subset.

For PDSCH with FDMSchemeB, there are two PDSCH occasions. Thus, the antenna port related information can be applied to a single TCI state only, or to both the two TCI states. For each TCI state, the mapping between antenna port subsets and time instance can be the same as that illustrated to SPS PDSCH, and thus will not be repeated.

Regarding PTRS related aspect determination for PDSCH with FDMSchemeB, it is similar to that of PDSCH with FDMSchemeA. A difference is: the associated DMRS port index may be different for different frequency domain resources in PDSCH with FDMSchemeB. The reason is that the antenna port set or subset for different frequency domain resources may be different, so the associated DMRS port for a PTRS port may be different.

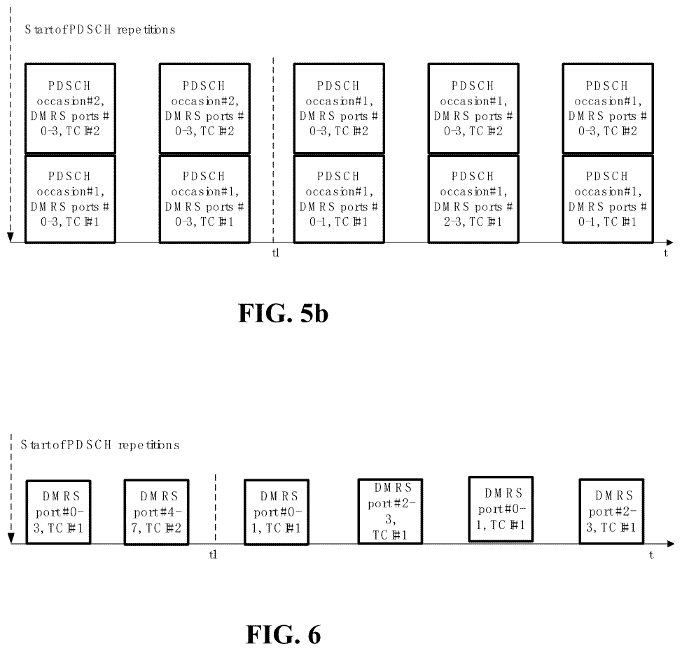

FIG. 5a is a schematic diagram illustrating a PDSCH with FDMSchemeA of dynamic adaption of spatial elements according to some embodiments of the present application, and FIG. 5b is a schematic diagram illustrating a PDSCH with FDMSchemeB of dynamic adaption of spatial elements according to some embodiments of the present application.

Referring to FIG. 5a, for the PDSCH with FDMSchemeA, there is a single PDSCH occasion, e.g., PDSCH occasion #1. For PDSCH occasion #1, there are 6 time instances and 6 repetitions on time domain shown as an example. In addition, there are two TCI states, e.g., TCI #1 and TCI #2 and one DMRS CDM group, e.g., a DMRS CDM group including four DMRS ports, e.g., DMRS ports #0 to #3 (corresponding to 4 antenna ports) in the PDSCH with FDMSchemeA. Antenna port related information is applicable in the UE side in time t1, which will be applied to both the two TCI states. In response to the application of the antenna port related information to each TCI state, an exemplary division manner of antenna port subsets associated with each TCI state is dividing the four antenna ports into 2 subsets associated with each TCI state, e.g., the first subset including antenna ports #0 to #1 (DMRS ports #0 to #1) and the second subset including antenna ports #2 to #3 (DMRS ports #2 to #3). The two subsets associated with the each TCI state are cyclically mapped to the corresponding time instance.

Referring to FIG. 5b, for the PDSCH with FDMSchemeB, there are two PDSCH occasions, e.g., PDSCH occasion #1 and PDSCH occasion #2, wherein PDSCH occasion #1 is associated with the first TCI state, e.g., TCI #1, and PDSCH occasion #2 is associated with the second TCI state, e.g., TCI #2. For each PDSCH occasion, there are 6 time instances and 6 repetitions on the time domain shown as an example. There is one DMRS CDM group, e.g., a DMRS CDM group including four DMRS ports, e.g., DMRS ports #0 to #3 (corresponding to 4 antenna ports) in the PDSCH with FDMSchemeB. In response to the application of the antenna port related information only to PDSCH occasion #1 associated with TCI #1 at time t1, an exemplary division manner of antenna port subsets associated with TCI #1 is dividing the four antenna ports into 2 subsets associated with each TCI state, e.g., the first subset including antenna ports #0 to #1 (DMRS ports #0 to #1) and the second subset including antenna ports #2 to #3 (DMRS ports #2 to #3). The two subsets associated with each TCI state are cyclically mapped to the corresponding time instance. PDSCH occasion #2 will not be impacted by the antenna port related information. In this case, for the frequency domain resource associated with the first TCI state, the associated DMRS port for a PTRS port may be different for different time instances, e.g. DMRS port #0 for the antenna port subset containing antenna ports #0 to #1, and DMRS port #2 for the antenna port subset containing antenna ports #2 to #3. For the frequency domain resource associated with the second TCI state, the associated DMRS port for a PTRS port will be DMRS port #0 for all time instances.

Besides the above PDSCH schemes, in some scenarios, there are PDSCH repetitions with two TCI states and two DMRS CDM groups, while no SFN scheme, e.g., SFNSchemeA or SFNSchemeB is configured. In such scenarios, in response to the application of antenna port related information, if all DMRS ports associated with a TCI state is dropped, the corresponding PDSCH occasion will be dropped. Regarding PTRS related aspect determination for PDSCH in such scenarios, the associated DMRS port will be determined based on the at least one antenna port subset after the application of the antenna port related information.

FIG. 6 is a schematic diagram illustrating non-SFN PDSCH repetitions of dynamic adaption of spatial elements according to some embodiments of the present application.

Referring to FIG. 6, the shown PDSCH with repetitions is configured with two TCI states, e.g., TCI #1 and TCI #2 and two DMRS CDM groups, e.g., a first DMRS CDM group associated with TCI #1 including DMRS ports #0 to #3 and a second DMRS CDM group associated with TCI #2 including DMRS ports #4 to #7. In response to the application of antenna port related information in time t1 (the number of antenna ports reduced from 8 to 2), DMRS ports #4 to #7 associated with TCI #2 will be dropped. Accordingly, the PDSCH occasion associated with DMRS ports #4 to #7 will be dropped. Only PDSCH occasion associated with DMRS ports #0 to #3, e.g., PDSCH occasion #1 will be received in the UE side. DMRS ports #0 to #3 are further divided into two subsets, e.g., a first subset including DMRS ports #0 and #1 and a second subset including DMRS ports #2 and #3, and the two subsets may be cyclically mapped to the time instances.

Regarding PUSCH with repetitions, similar operations can be adopted as that for SPS PDSCH in response to the application of antenna port related information, especially, including but not limited to determination (or mapping) of the antenna port subset for each time instance and determination of the number of time instances for PUSCH repetitions. Thus, only distinct difference of the PUSCH from PDSCH will be illustrated. Persons skilled in the art should well know that although the current PUSCH does not define the TDM scheme and FDM scheme similar to PDSCH, the above solutions illustrated for PDSCH with TDM scheme and FDM scheme etc. will also be applied to the PDSCH in the future if similar schemes are defined for PUSCH as the 3GPP evolution.

One difference is the joint channel estimation of PUSCH. Considering the joint channel estimation of PUSCH, it is preferred that the mapping between antenna port subset and time instances is repetition number first, which is determined by the joint channel estimation window size, and antenna port subset secondly.

For example, 4 antenna ports, e.g., ports #0 to #3 are configured for PUSCH before the application of the antenna port related information. In response the antenna port related information indicating the antenna port number reduced to 2, two antenna port subsets, a first subset, e.g., subset #1 including antenna ports #0 and 1 and a second subset, e.g., subset #2 including antenna ports #2 and 3 are determined. If the window duration of joint channel estimation is 4 and the repetition number is 6, then the mapping will be subset #1, subset #1, subset #1, subset #1, subset #2, subset #2, subset #2, subset #2, subset #1, subset #1, subset #2, and subset #2. The staring position of the joint channel estimation window for the first subset and the second subset are different.

After the application of the antenna port related information, the RE location for the DMRS port can be the same or updated based on the antenna port subset(s). The precoder for the same DMRS port before and after the application of the antenna port related information is the same. For example, in the case that the antenna ports are divided into two subsets, e.g., {#0, #1} and {#2, #3} from antenna ports #0-3, the RE location for antenna ports #2 and 3 after the application of the antenna related information will be based on the RE positions of antenna ports #0 and 1 or antenna ports #2 and 3 before the application of the antenna related information.

Regarding PTRS related aspect determination for PUSCH, for codebook based PUSCH, the associated DMRS port is determined based on the adjusted DMRS ports (or DMRS port subset) and the precoder associated with the corresponding DMRS port. For non-codebook based PUSCH, the associated DMRS port is determined based on the SRS resource associated with the adjusted DMRS ports, and interpretation of the corresponding DCI is also based on the updated DMRS ports.

For example, in response to the application of antenna port related information, DMRS ports #0-4 are updated into two DMRS port subsets, e.g., {#0, #1} {#2, #3}. DMRS ports #0, 1, 2 and 3 are respectively associated with SRS resources #0, 1, 2 and 3 by SRI indicators. SRS resources #0 and #1 are associated with PTRS #0, and SRS resources #2 and #3 are associated with PTRS #1. Before the application of antenna port related information, there will be two PTRS ports, e.g., PTRS ports #0 and 1. Exemplary DCI will indicate “00” for PTRS port and DMRS port association, e.g., PTRS port #0 being associated with DMRS port #0 and PTRS port #1 being associated with DMRS port #2 respectively.

In response to the application of the antenna port related information, there will be one PTRS port for each time instance. For the time instance with DMRS ports #0 and 1, the associated DMRS port for PTRS port is DMRS port #0. For the time instance with DMRS ports #2 and 3, the associated DMRS port for PTRS port is DMRS port #2. The PTRS RE location will be same or different for time instance with DMRS ports #0 and 1 and DMRS ports #2 and 3.

In another exemplary scenario, it is assumed that SRS resources #0 and 2 are associated with PTRS port #0 and SRS resources #1 and 3 are associated with PTRS port #1. There will be two PTRS ports for each time instance. For the time instance associated with DMRS ports #0 and 1, PTRS ports #0 and 1 will be associated with DMRS ports #0 and 1, respectively. For the time instance associated with DMRS ports #2 and 3, PTRS ports #0 and 1 will be associated with DMRS ports #2 and 3, respectively. The PTRS RE location will be the same for time instance with DMRS ports #0 and 1 and DMRS ports #2 and 3.

Besides the methods, embodiments of the present application also propose an apparatus of dynamic adaption of spatial elements.

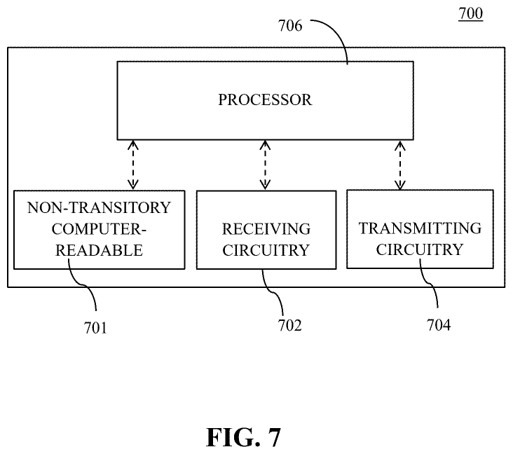

For example, FIG. 7 illustrates a block diagram of an apparatus of dynamic adaption of spatial elements 700 according to some embodiments of the present application.

As shown in FIG. 7, the apparatus 700 may include at least one non-transitory computer-readable medium 701, at least one receiving circuitry 702, at least one transmitting circuitry 704, and at least one processor 706 coupled to the non-transitory computer-readable medium 701, the receiving circuitry 702 and the transmitting circuitry 704. The at least one processor 706 may be a CPU, a DSP, a microprocessor etc. The apparatus 700 may be a RAN node, e.g., a gNB or a remote apparatus, e.g., a UE configured to perform a method illustrated in the above or the like.

Although in this figure, elements such as the at least one processor 706, transmitting circuitry 704, and receiving circuitry 702 are described in the singular, the plural is contemplated unless a limitation to the singular is explicitly stated. In some embodiments of the present application, the receiving circuitry 702 and the transmitting circuitry 704 can be combined into a single device, such as a transceiver. In certain embodiments of the present application, the apparatus 700 may further include an input device, a memory, and/or other components.

In some embodiments of the present application, the non-transitory computer-readable medium 701 may have stored thereon computer-executable instructions to cause a processor to implement the method with respect to the RAN node, e.g., the gNB as described above. For example, the computer-executable instructions, when executed, cause the processor 706 interacting with receiving circuitry 702 and transmitting circuitry 704, so as to perform the steps with respect to the RAN node as depicted above.

In some embodiments of the present application, the non-transitory computer-readable medium 701 may have stored thereon computer-executable instructions to cause a processor to implement the method with respect to the remote apparatus, e.g., the UE as described above. For example, the computer-executable instructions, when executed, cause the processor 706 interacting with receiving circuitry 702 and transmitting circuitry 704, so as to perform the steps with respect to the remote apparatus as illustrated above.

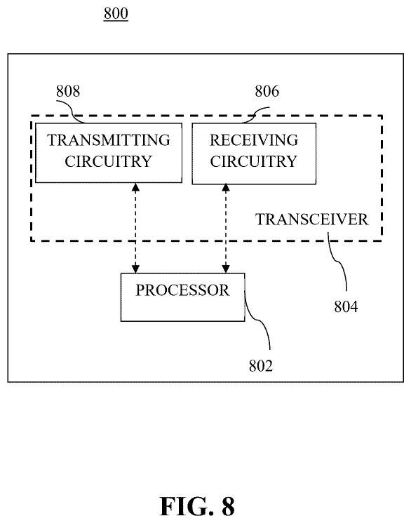

FIG. 8 is a block diagram of an apparatus of dynamic adaption of spatial elements 800 according to some other embodiments of the present application.

Referring to FIG. 8, the apparatus 800, for example a gNB or a UE may include at least one processor 802 and at least one transceiver 804 coupled to the at least one processor 802. The transceiver 804 may include at least one separate receiving circuitry 806 and transmitting circuitry 804, or at least one integrated receiving circuitry 806 and transmitting circuitry 804. The at least one processor 802 may be a CPU, a DSP, a microprocessor etc.

According to some embodiments of the present application, the apparatus 800 is a RAN node, e.g., a gNB, which includes: a transceiver; and a processor coupled to the transceiver, wherein the processor is configured to: transmit, via the transceiver, configuration information on at least one of: PDSCH with repetitions or PUSCH with repetitions; transmit, via the transceiver, antenna port related information; and perform the at least one of PDSCH with repetitions or PUSCH with repetitions at least based on the antenna port related information in response to application of the antenna port related information.

According to some embodiments of the present application, the apparatus 800 is a remote apparatus, e.g., a UE, which includes: a transceiver; and a processor coupled to the transceiver, wherein the processor is configured to: receive, via the transceiver, configuration information on at least one of: PDSCH with repetitions or PUSCH with repetitions; receive, via the transceiver, antenna port related information; and perform the at least one of PDSCH with repetitions or PUSCH with repetitions at least based on the antenna port related information in response to application of the antenna port related information.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
receive configuration information on at least one of: physical downlink shared channel (PDSCH) with repetitions or physical uplink shared channel (PUSCH) with repetitions;
receive antenna port related information; and
perform at least one of the PDSCH with repetitions or the PUSCH with repetitions based at least on the antenna port related information in response to application of the antenna port related information.

2. The UE of claim 1, wherein the at least one processor is configured to cause the UE to perform the PDSCH with repetitions or the PUSCH with repetitions based at least on the antenna port related information by:
discarding remaining repetitions of the PDSCH with repetitions or the PUSCH with repetitions when the remaining repetitions are after the application of the antenna port related information.

3. The UE of claim 1, wherein the at least one processor is configured to cause the UE to perform the PDSCH with repetitions or the PUSCH with repetitions based at least on the antenna port related information by:
performing the PDSCH with repetitions or the PUSCH with repetitions with at least one antenna port subset in response to the application of the antenna port related information, wherein each antenna port subset of the at least one antenna port subset is a different subset of an antenna port set associated with the PDSCH with repetitions or the PUSCH with repetitions before the application of the antenna port related information and is different from the antenna port set.

4. The UE of claim 3, wherein the at least one antenna port subset is configured or is determined based on the antenna port set and the antenna port related information.

5. The UE of claim 3, wherein different antenna port subsets are mapped with different time instances of the PDSCH with repetitions or the PUSCH with repetitions.

6. The UE of claim 3, wherein at least one of a demodulation reference signal (DMRS) resource element (RE) location, a DMRS port index, a phase tracking reference signal (PTRS) port index, a PTRS RE location or an associated DMRS port for a PTRS port for each time instance, is determined based on a corresponding one of the at least antenna port subset, and the corresponding one is an antenna port subset for each time instance or is determined as an antenna port subset associated with a first time instance after the application of the antenna port related information.

7. The UE of claim 6 wherein, the PTRS RE location is determined based on a modulation and coding scheme associated with the corresponding one of the at least antenna port subset.

8. The UE of claim 3, wherein, when different repetitions of the PDSCH with repetitions or the PUSCH with repetitions at different time instances are associated with different transmission configuration indication (TCI) states, the antenna port related information is applied to one of the TCI states or to all the TCI states.

9. The UE of claim 3, wherein, when different repetitions of the PDSCH with repetitions or the PUSCH with repetitions for different frequency domain resource sets are associated with different transmission configuration indication (TCI) states, the antenna port related information is applied to one of the TCI states or all the TCI states.

10. The UE of claim 9, wherein at least one of a phase tracking reference signal (PTRS) port index or an associated demodulation reference signal (DMRS) port for a PTRS port for each frequency domain resource set is determined based on an antenna port subset associated with a corresponding frequency domain resource set.

11. The UE of claim 3, wherein, when there are two transmission configuration indication (TCI) states and two demodulation reference signal (DMRS) code division multiplexing (CDM) groups, different repetitions of the PDSCH with repetitions or the PUSCH with repetitions are associated with different TCI states and different DMRS CDM groups, and a PDSCH repetition or a PUSCH repetition in a time instance associated with a TCI state is dropped in response to associated DMRS ports within a DMRS CDM group being dropped in response to the application of the antenna port related information.

12. The UE of claim 1, wherein the antenna port related information is separately configured or jointly configured for downlink and uplink.

13. The UE of claim 1, wherein an application time of the antenna port related information is configured or is determined based on a time instance when all configured PDSCH with repetitions or PUSCH with repetitions are performed before receiving the antenna port related information.

14. A radio access network (RAN) node for wireless communication, comprising:
at least one memory; and
at least one processor coupled with the at least one memory and configured to:
transmit configuration information on at least one of: a physical downlink shared channel (PDSCH) with repetitions or a physical uplink shared channel (PUSCH) with repetitions;
transmit antenna port related information; and
perform the PDSCH with repetitions or the PUSCH with repetitions based on the antenna port related information in response to application of the antenna port related information.

15. A method performed by a user equipment (UE), the method comprising:
receiving configuration information on at least one of: a physical downlink shared channel (PDSCH) with repetitions or a physical uplink shared channel (PUSCH) with repetitions;
receiving antenna port related information; and
performing the PDSCH with repetitions or the PUSCH with repetitions based at least on the antenna port related information in response to application of the antenna port related information.

16. The method of claim 15, wherein performing the PDSCH with repetitions or the PUSCH with repetitions comprises:
discarding remaining repetitions of the PDSCH with repetitions or the PUSCH with repetitions when the remaining repetitions are after the application of the antenna port related information.

17. The method of claim 15, wherein performing the PDSCH with repetitions or the PUSCH with repetitions comprises:
performing the PDSCH with repetitions or the PUSCH with repetitions with at least one antenna port subset in response to the application of the antenna port related information, wherein each antenna port subset of the at least one antenna port subset is a different subset of an antenna port set associated with the PDSCH with repetitions or the PUSCH with repetitions before the application of the antenna port related information and is different from the antenna port set.

18. The method of claim 15, wherein the antenna port related information is separately configured or jointly configured for downlink and uplink.

19. The method of claim 15, wherein an application time of the antenna port related information is configured or is determined based on a time instance when all configured PDSCH with repetitions or PUSCH with repetitions are performed before receiving the antenna port related information.

20. A remote apparatus for wireless communication, comprising:
at least one memory; and
at least one processor coupled with the at least one memory and configured to cause the remote apparatus to:
receive configuration information on at least one of: physical downlink shared channel (PDSCH) with repetitions or physical uplink shared channel (PUSCH) with repetitions;
receive antenna port related information; and
perform at least one of the PDSCH with repetitions or the PUSCH with repetitions based at least on the antenna port related information in response to application of the antenna port related information.
